(19) United States
(12) Patent Application Publication
(10) Pub. No.: US 2023/0024716 A1
(43) Pub. Date: Jan. 26, 2023

(54) METHOD FOR CALCULATING A TARGET PROFILE FOR THE MOVEMENT OF AN INJECTION ACTUATOR SHAPING MACHINE AND/OR SIMULATING THE INJECTING THE MOLDING COMPOUND INTO A CAVITY

(71) Applicant: ENGEL AUSTRIA GmbH, Schwertberg (AT)

(72) Inventors: Stefan KLEINDEL, Wien (AT); Paul Joachim WAGNER, Asten (AT); Alfred ANGERER, Perg (AT)

(21) Appl. No.: 17/871,447

(22) Filed: Jul. 22, 2022

(30) Foreign Application Priority Data
Jul. 23, 2021 (AT) A 50618/2021

(51) Int. Cl. B29C 45/80; G06F 30/28

(52) U.S. Cl. CPC B29C 45/80; G06F 30/28; B29K 2101/12

(57) ABSTRACT

A computer-implemented method for calculating a nominal profile for the movement of an injection actuator of a molding machine includes defining a simulation domain comprising at least one cavity of a mold installed on the molding machine. At least one simulation is performed in the simulation domain, and injection of a molding material into the at least one cavity of the mold is simulated by predefining at least one volume flow profile through an inlet face at the edge of the simulation domain and/or by predefining at least one pressure profile at the inlet face as boundary condition. A volume flow profile calculated using the simulation and/or the at least one volume flow profile is converted into a nominal profile for the movement of an injection actuator, in particular a plasticizing screw, and a compressibility of the molding material is taken into account in the conversion.

The invention relates to a computer-implemented method for calculating a nominal profile for an injection actuator of a molding machine and a computer-implemented method for simulating the injection of the molding material into a cavity. The invention furthermore relates to a method for operating a molding machine according to claim 14 and a method for the transfer and adaptation of a nominal profile for the movement of the injection actuator according to claim 15. The invention also relates to a molding machine according to claim 16 and a computer program product according to claim 17 or 18.

Computer-implemented methods of the named type and methods for operating a molding machine are already known from the state of the art.

The specification U.S. Pat. No. 10,960,592 B2 discloses a method for operating an injection-molding machine, wherein, among other things, a simulation domain is defined, which comprises the mold cavity, the barrel of the injection-molding machine and the injection actuator of the injection-molding machine. At least one simulation on a defined mesh is performed on this simulation domain. Boundary conditions in the barrel are determined taking the movement of the injection actuator into account. The injection of a molding material from the barrel into the mold cavity is thus simulated by means of numerical methods. Setting parameters obtained therefrom can be easily transferred to the injection-molding machine, wherein a real injection-molding process can then be performed. Thus, for example, the filling behavior of the cavity can be simulated.

A disadvantage of this state of the art is that an operator's machine-specific knowledge such as screw diameter, metering stroke, etc. is necessary in order to carry out the simulation correctly, as among other things the movement of the injection actuator also has to be simulated. In addition, in the case of such complex simulations which simulate the entire injection process, optimizations can only be carried out with difficulty.

The object of the invention is to create a computer-implemented method for calculating a nominal profile for an injection actuator of a molding machine and a computer-implemented method for simulating the injection of the molding material into the cavity, which can be set up easily and/or without in-depth knowledge of the molding machine by an operator and which are easily optimizable.

In the computer-implemented method according to the invention for calculating a nominal profile for an injection actuator of a molding machine and in the computer-implemented method according to the invention for simulating the injection of the molding material into the cavity, it is provided that a simulation domain is defined, wherein the simulation domain comprises at least one cavity of a mold installed on the molding machine. It is also provided that at least one simulation is performed in the simulation domain, wherein the injection of a molding material into the at least one cavity of the mold is simulated by predefining at least one volume flow profile through an inlet face at the edge of the simulation domain and/or by predefining at least one pressure profile at the inlet face as boundary condition.

According to the invention, only the at least one cavity of the mold has to be modeled in the simulation domain and for example the plasticizing screw, or in general an injection actuator for the injection, can be left out.

The movement of the injection actuator therefore need not also be simulated in a complex manner. The simulation can thus also be carried out faster and with fewer memory resources, as a result of which an optimization can be carried out more efficiently.

Moreover, the boundary conditions (volume flow profile and/or pressure profile) need not be predefined in absolute values, but rather can for example be parameterized over a desired injection time. As a result, the simulation advantageously becomes independent of the machine.

It is provided according to the invention that a volume flow profile calculated using the simulation and/or the at least one volume flow profile is converted into a nominal profile for the movement of an injection actuator, in particular a plasticizing screw.

By converting the at least one volume flow profile through the inlet face into a nominal profile for the movement of an injection actuator, a nominal profile for the injection actuator can be calculated in spite of the use of a simplified simulation in the simulation domain without taking the molding material between the injection actuator and the inlet face into account. This nominal profile can then be used to operate the molding machine and/or for further simulations. An in-depth machine-specific knowledge is not required and the nominal profile can nevertheless be transferred without any problems to the molding machine, as a result of which the method can be utilized much more effectively than known methods.

The invention is therefore based on the knowledge that, with the aid of a machine-independent simulation and a subsequent conversion which takes the compressibility of the molding material into account, a simulation which is faster compared with the state of the art and has adequate precision can be achieved.

In the computer-implemented method according to the invention, it can be provided in this sense that a mathematical model for calculating the mass of the molding material between the injection actuator and the inlet face, taking its compressibility into account, is used in the conversion.

It can be provided that the compressibility of the molding material between the injection actuator and the inlet face is taken into account in the conversion.

It can also be provided that the compressibility of the molding material is taken into account in the conversion by scaling the nominal profile and/or the nominal volume flow profile such that, based on a time index and/or a volume flow index, a volume resulting from the nominal profile and entering the inlet face corresponds to a volume of the molding material calculated in the simulation. The nominal profile can preferably be calculated before the scaling without taking the compressibility into account.

To put it simply, in such embodiments the compressibility of the molding material can therefore be easily taken into account for the conversion by scaling the nominal profile and/or the nominal volume flow profile such that the volume of the molding material which, according to the nominal profile and/or the nominal volume flow profile, reaches the simulation domain at a certain time (for example time index=predefined injection time) or with a certain volume flow rate (for example time index=predefined volume flow parameter) matches a volume in the simulation domain calculated in the simulation.

As mentioned, according to the invention the molding material between the injection actuator and the inlet face need not also be simulated and an accurate nominal profile of the injection actuator can nevertheless be obtained taking the compressibility into account.

In the computer-implemented method according to the invention according to claim 2, it is additionally provided that an overall simulation is carried out, wherein the overall simulation simulates the injection of the molding material into the cavity of the mold and the molding material in a barrel of the molding machine taking into account the movement of the injection actuator according to the nominal profile (machine-dependent simulation).

Thus, the simulation which can be carried out easily and efficiently without taking the molding material between the injection actuator and the inlet face into account can provide or improve a suitable nominal profile for an overall simulation which also simulates the molding material between the injection actuator and the inlet face.

Thus, for example, an optimization with respect to a desired simulation result can be carried out easily by means of the first simulation, wherein the nominal profile of the injection actuator is then used in the overall simulation (combination of claims 1 and 2). As a result, a further optimization at the level of the overall simulation can for example be carried out, wherein the nominal profile from the first simulation provides a suitable initial value.

The volume flow profile calculated in the simulation can particularly preferably apply at the edge of the simulation domain, in particular at the inlet face. It should be mentioned that, as a rule, a difference between the volume flow profile predefined as boundary condition and the volume flow profile calculated in the simulation arises, which can reflect an optimization carried out in the simulation. This represents a functionality of available software for simulating molding processes, in particular injection-molding processes.

By molding machines may be meant injection-molding machines, transfer-molding machines, molding presses and the like.

In one embodiment example, it is provided that an optimization of the boundary conditions is carried out. Several simulations are preferably carried out iteratively with different boundary conditions. It can particularly preferably be provided that the boundary conditions are adapted to at least one simulation performed beforehand depending on the simulation result. An optimization in response to a desired simulation result can thus be carried out. For example, a melt front speed that is as constant as possible in the cavity can be desired.

In a further embodiment example, it is provided that the simulation domain comprises at least one sprue region. In the simulation, the molding material is therefore also simulated in the sprue region and in the cavity.

It can alternatively or additionally be provided that the simulation domain comprises at least one machine nozzle. In the simulation, the molding material is here, for example, also simulated in the sprue region, the machine nozzle and in the cavity.

It can alternatively or additionally be provided that the simulation domain comprises at least one barrel flange. In the simulation, the molding material is here, for example, also simulated in the sprue region, the machine nozzle, the barrel flange and in the cavity.

In all named examples of the simulation domain, the movement of the injection actuator need not be taken into account. The simulation can therefore be carried out easily.

A hot runner can likewise alternatively or additionally also be simulated. If the hot runner is not also simulated, an approximate calculation can be used with respect to the hot runner.

In one embodiment example, the simulation and/or the overall simulation is a CFD simulation. CFD here stands for “computational fluid dynamics”, thus numerical flow dynamics. For this, a mesh is typically introduced in the simulation domain.

A volume flow profile through the inlet face at the edge of the simulation domain can be predefined as boundary condition.

Alternatively or additionally, the at least one simulation can be carried out by predefining at least one pressure profile at the inlet face as boundary condition.

A pressure profile can be calculated from the volume flow profile and a volume flow profile can be calculated from the pressure profile. At the inlet face, at least one volume flow profile or at least one pressure profile are thus predefined as boundary conditions, for example at fixed points in time.

In principle, mixed forms consisting of a volume flow profile and a pressure profile (at different points in time) are also conceivable as boundary condition.

It can be provided that a density profile at the inlet face is calculated from the volume flow profile and/or the pressure profile at the inlet face. For this, a physical model can preferably be used for the relationship between pressure, temperature and density, particularly preferably a Tait approach, a Renner approach and/or an IKV (Institut für Kunststoffverarbeitung-Institute for Plastics Processing) approach. The compressibility of the molding material at the inlet face is thus taken into account, irrespective of the fact that the compressibility can also be taken into account in other regions. Together with the volume flow profile at the inlet face, a mass profile of the material which flows through the inlet face can thus be calculated. Of course, as is often usual, the specific volume can also be used instead of the density.

It may be noted here that the mathematical model for calculating the mass of the molding material between the injection actuator and the inlet face mentioned in this embodiment example therefore includes a physical model for the relationship between pressure, temperature and density in one step. The compressibility of the molding material is therefore taken into account in the conversion, in particular by means of the physical model.

The different approaches mentioned (Tait, Renner, IKV) are in principle known per se among those skilled in the art. In addition, reference is made to the article “Schmelzekompression praxisnah berechnen” [“calculating melt compression practically”] that appeared in the journal “Kunststoffe” [“Plastics”] on 9 Jun. 2020.

With regard to the IKV approach, reference can additionally be made to the Master's thesis by Hans-Jürgen Luger with the title “Reale and virtuelle Prozessoptimierung einer Spiegelantriebskomponente” [“Real and virtual process optimization of a mirror drive component”] submitted at Montan University (Leoben) (August 2013).

In a further embodiment example, it can be provided that the molding material between the injection actuator and the inlet face is assigned a barrel pressure profile and/or a spatial pressure distribution profile using the at least one pressure profile at the inlet face. A value of the pressure is thus also obtained outside the simulation domain.

It is preferably provided that the barrel pressure profile or the pressure distribution profile of the molding material between the injection actuator and the inlet face is assumed to be spatially uniform and/or to correspond to the pressure profile at the inlet face. The pressure is therefore generalized to the region outside the simulation domain. It can also be provided that the pressure profile of the molding material between the injection actuator and the inlet face is assumed to be ascending or descending with a gradient. Thus, even more realistic results can possibly be achieved.

In a further embodiment example, a density profile and/or a spatial density distribution profile of the molding material between the injection actuator and the inlet face is calculated from the barrel pressure profile and/or the spatial pressure distribution profile of the molding material between the injection actuator and the inlet face. Again, a physical model can preferably be used here for the relationship between pressure, temperature and density, particularly preferably a Tait approach, a Renner approach and/or an IKV approach. The compressibility of the molding material between the injection actuator and the inlet face is thus taken into account. A mass of the molding material between the injection actuator and the inlet face can thus be calculated in dependence on a known volume. A volume of the molding material between the injection actuator and the inlet face can thus also be calculated in dependence on a known mass.

In a further embodiment example, it is provided that the mass profile of the molding material between the injection actuator and the inlet face is determined, in particular iteratively, via a mass balance. It is preferably provided that a mass of the molding material flowing off into the simulation domain is calculated from the at least one volume flow profile through the inlet face and the at least one barrel pressure profile at the inlet face and is particularly preferably iteratively subtracted from the mass in the barrel. For the calculation, a previously named physical model is particularly preferably used for the relationship between pressure, temperature and density. The mass flowing off into the simulation domain can be calculated from the product of volume flow rate at the inlet face, density at the inlet face and time interval.

In addition, it can be provided that a mass of the molding material flowing off via a non-return valve of the injection actuator is taken into account. The conversion can thus be carried out even more realistically.

In a further embodiment example, a nominal volume flow profile of the molding material between the injection actuator and the inlet face is calculated from the mass profile. The nominal volume flow profile describes the change in the volume of the molding material at different points in time. The density profile and/or the density distribution profile of the molding material between the injection actuator and the inlet face is preferably used in the calculation.

A nominal profile for the movement of the injection actuator can be calculated from the nominal volume flow profile. Here, the geometric conditions of the injection actuator and the barrel are particularly preferably taken into account.

It can be provided that the number of points of the nominal profile for the movement of the injection actuator is reduced by means of a reduction algorithm to an amount that is suitable for the machine control system of the molding machine. This can be advantageous in order to transfer the nominal profile for the movement of the injection actuator to the molding machine.

The Ramer-Douglas-Peucker algorithm can for example be used as reduction algorithm.

A method for operating a molding machine comprises the following steps:
a nominal profile for the movement of the injection actuator of the molding machine is calculated according to the invention,
the nominal profile for the movement of the injection actuator is transferred to the molding machine,
a molding process is performed on the molding machine using the nominal profile for the movement of the injection actuator.

The nominal profile with the advantageous properties from the simulation can thus be used in a real molding process.

Alternatively, the nominal profile for the movement of an injection actuator can be transferred to a piece of software, for example a virtual molding machine (for example VirtMould).

In practice, it may become necessary to transfer a mold, which is installed on a further molding machine, to the molding machine, i.e. to uninstall it from the further molding machine and to install it on the molding machine. To put it another way, it may become necessary to transfer the molding process carried out with the mold from a further molding machine to the molding machine.

A further aspect of the present invention results from this, namely that the method according to the invention with the conversion according to the invention can also be used to calculate a nominal profile for the movement of the injection actuator of the molding machine from a molding process which has already been set up and is running on the further molding machine.

A corresponding method for the transfer and adaptation of a nominal profile for the movement of an injection actuator from a further molding machine to the at least one molding machine according to claim 13 comprises the following method steps:

In a first method step, at least one molding process is performed on at least one further molding machine with a nominal profile for the movement of a first injection actuator.

In a second method step, at least one further overall simulation of the at least one molding process is carried out on the further molding machine. Simulated process variables of the at least one molding process can thus be stored.

In a third method step, a further simulation domain is defined, wherein the further simulation domain comprises the at least one cavity of the mold installed on the further molding machine.

In a fourth method step, the nominal profile for the movement of a further injection actuator of the further molding machine is converted into a volume flow profile through an inlet face and/or at least one pressure profile at the inlet face at the edge of the further simulation domain.

In a fifth method step, the computer-implemented method according to the invention is then carried out with the volume flow profile and/or the pressure profile.

In particular, a nominal profile for the movement of the injection actuator of the molding machine is therefore calculated. The nominal profile was thus transferred from the further molding machine to the molding machine and adapted to the molding machine. This is in particular useful if the same mold is used on the molding machine and on the further molding machine.

The simulation domain and the further simulation domain are the same if the simulation domain comprises only the mold. Otherwise, a corresponding further simulation domain is chosen, which resembles the simulation domain.

A molding machine is also provided which is suitable for performing the method for operating a molding machine and the method for the transfer and adaptation of a nominal profile for the movement of the injection actuator from a further molding machine to the at least one molding machine.

A computer program product is also provided, comprising commands which cause the molding machine to perform the method for operating a molding machine and the method for the transfer of a nominal profile for the movement of the injection actuator from a further molding machine to the at least one molding machine.

Finally, protection is also sought for a computer program which contains commands which prompt a computer executing them to perform a method according to the invention with the predefined simulation domain.

The computer-implemented methods can be performed on an arithmetic unit of the molding machine. The computer-implemented method can, however, preferably be performed on an external computer (for example connected to the molding machine with a remote data transmission connection) and/or a cloud (for example implemented as a customer portal of the molding machine manufacturer). This can be in data communication with the molding machine.

In this document, the suffix “profile” denotes a temporal progression of a process variable with particular points in time. A progression of a process variable as a function of another, continuous process variable can also be meant. A volume flow profile can for example be a volume over time or volume over the degree of filling of the cavity. The progression over a portion of a cycle of the molding process is thus preferably meant.

In the present document, the at least one volume flow profile and/or the at least one pressure profile is sometimes simply called volume flow profile and/or pressure profile because, in most cases, a single volume flow profile and/or pressure profile is used. However, it is clear to those skilled in the art that several volume flow profiles and/or pressure profiles can also be used.

Further embodiment examples and details can be found in the figures. There are shown in:

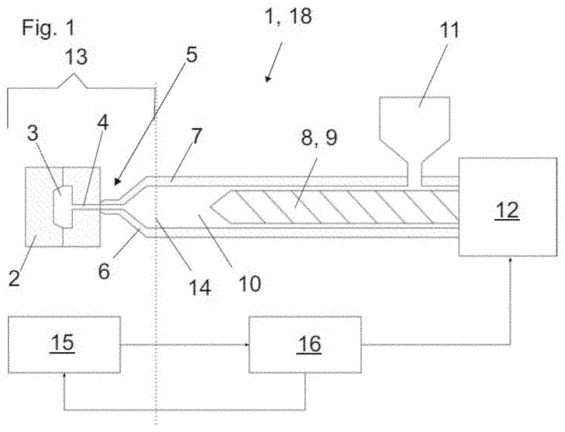

FIG. 1 schematic representation of an injection unit and a mold of a molding machine

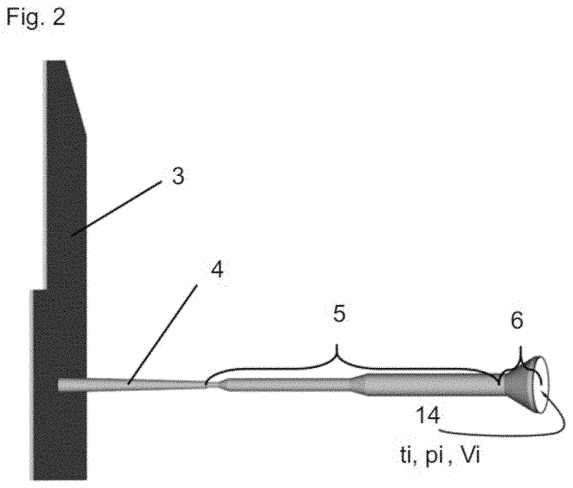

FIG. 2 cavity, sprue region, machine nozzle and barrel flange

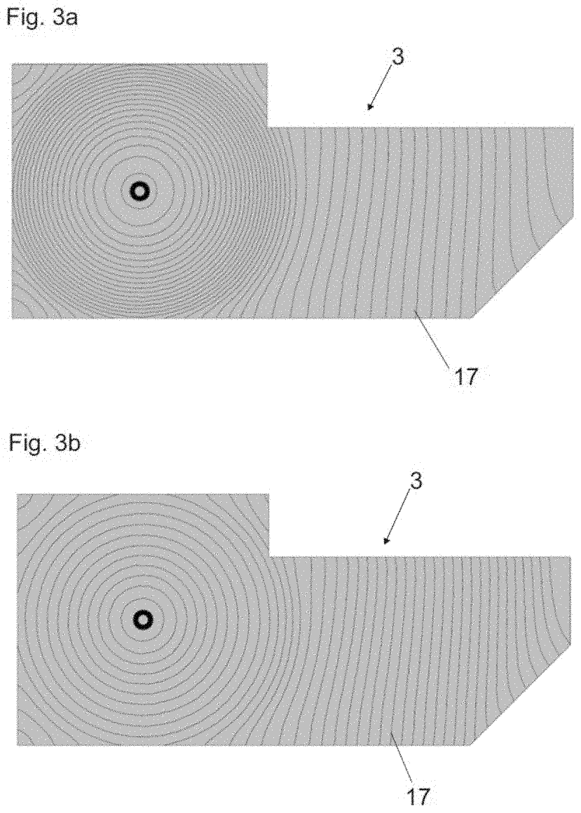

FIG. 3a melt fronts in a cavity of a mold before an optimization

FIG. 3b melt fronts in a cavity after an optimization

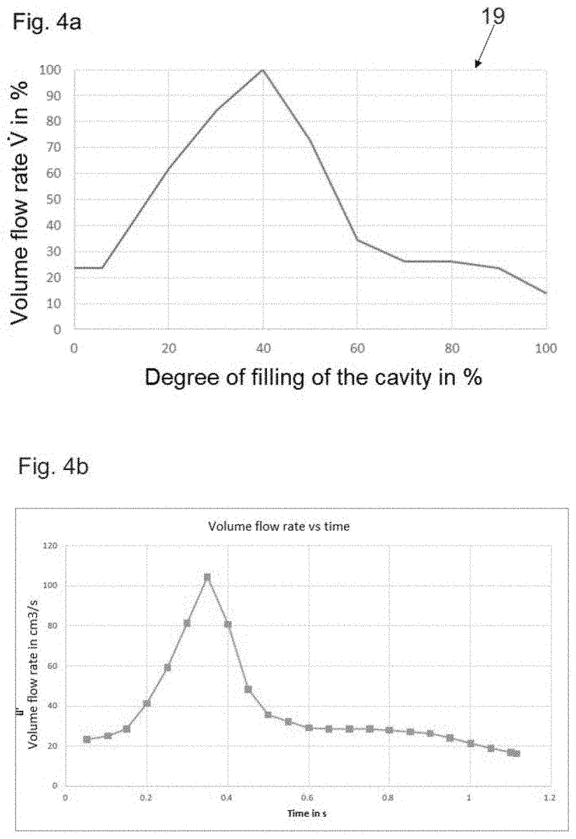

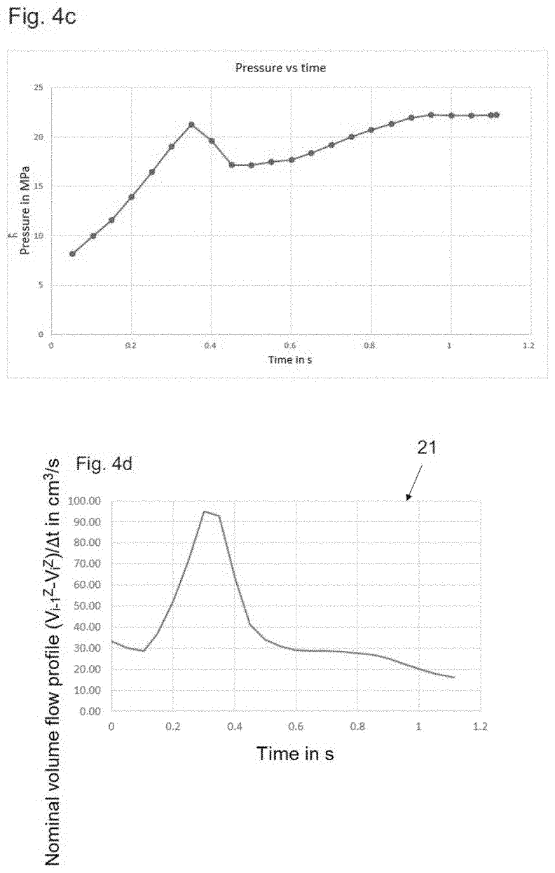

FIG. 4a volume flow profile at the inlet face as a function of the degree of filling of the cavity of the mold as boundary condition of a simulation

FIG. 4b volume flow profile calculated in the simulation over time

FIG. 4c pressure profile calculated in the simulation over time

FIG. 4d nominal volume flow profile of the molding material between the injection actuator and the inlet face as a function of time

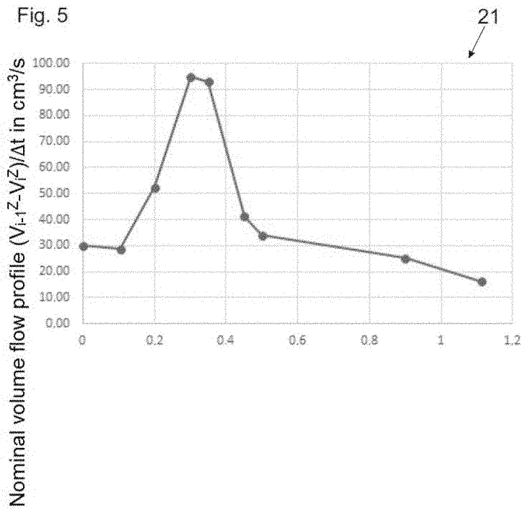

FIG. 5 nominal volume flow profile of the molding material between the injection actuator and the inlet face as a function of time with a reduced number of points

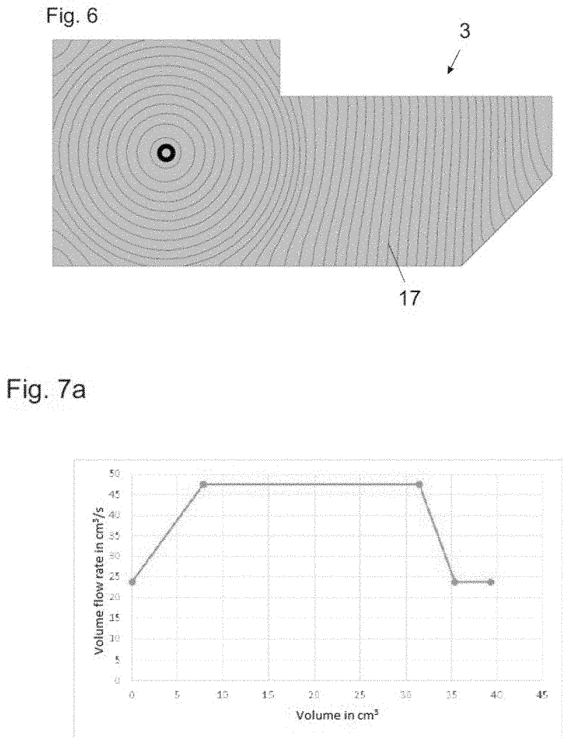

FIG. 6 melt fronts in a cavity using the nominal profile for the movement of the injection actuator

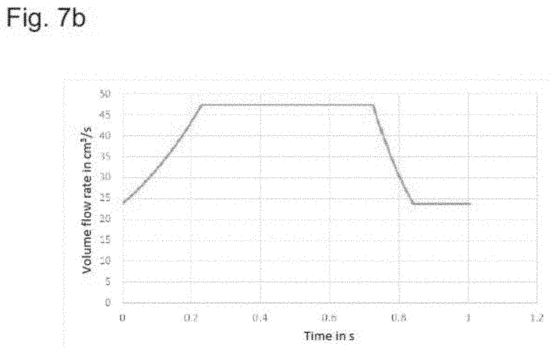

FIG. 7a a volume flow rate as a function of a filled volume

FIG. 7b a volume flow rate as a function of a time

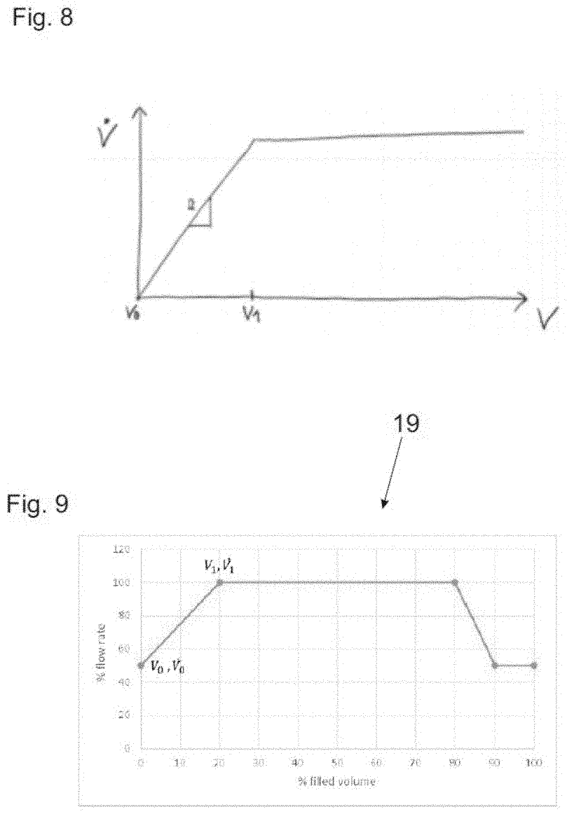

FIG. 8 a graph to illustrate the conversion between FIGS. 7a and 7b

FIG. 9 a volume flow profile calculated in a simulation expressed in relative units

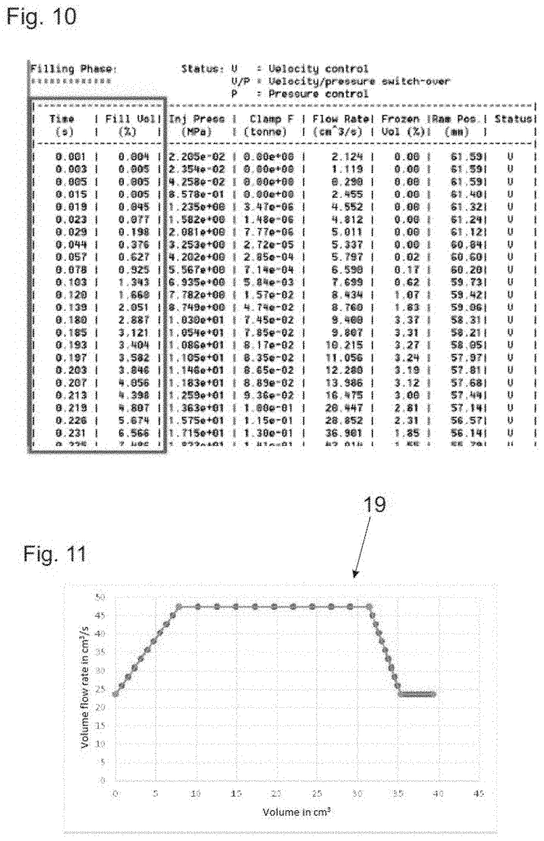

FIG. 10 an extract from an example of a simulation result

FIG. 11 the volume flow profile from FIG. 9 with illustrated interpolation points

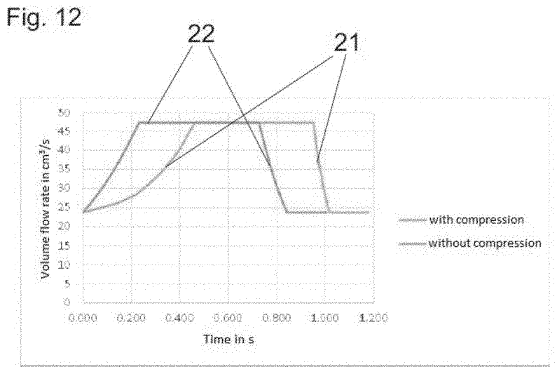

FIG. 12 a graph to illustrate an embodiment example of a conversion according to the invention

FIG. 1 shows a schematic representation of an injection unit 18 of a molding machine 1 with a mold 2 installed on it. The molding machine comprises an injection actuator 8 in the form of a plasticizing screw 9. Thermoplastic material in the form of granules can be poured into the barrel 7 via a hopper 11 and is plasticized by the plasticizing screw 9. The molding material thus forming is metered in front of the plasticizing screw 9.

In the injection process the molding material is injected via the machine nozzle 5 and via the sprue region 4 and a cavity 3 of the mold 2.

FIG. 2 shows a detailed view of the sprue region 4, the machine nozzle 5 and the barrel flange 6 with the inlet face 14. A volume flow \dot{V}ᵢ passes through the inlet face 14 at the point in time tᵢ, wherein a pressure pᵢ prevails there.

The present invention is concerned with simulating the injection process. With it, for example, the filling behavior of a cavity 3 of a mold 2 can be predicted. With it, optimizations can also be carried out relatively easily, wherein at least one particular process variable can be optimized, which is not accessible experimentally. For example, an optimization to give a constant melt front speed can be carried out.

In the computer-implemented method according to the invention for calculating a nominal profile for the movement of the injection actuator 8 of the molding machine 1 and in the computer-implemented method for simulating the injection of the molding material 10 into a cavity 3 a simulation domain 13 is defined, wherein the simulation domain 13 comprises at least one cavity 3 of a mold 2 installed on the molding machine 1. In the embodiment example in FIG. 1, the simulation domain 13 also comprises the sprue region 4, the machine nozzle 5 and the barrel flange 6.

In this embodiment example, the boundary of the simulation domain 13 displayed as a vertical dotted line is so far to the right in the image that, in principle, it may be the case that the plasticizing screw 9 penetrates into the simulation domain 13, which will generally not be the case, however. The injection actuator 8 is not taken into account in the simulation 15. It is not to be assumed that a decrease in the accuracy of the method according to the invention thereby occurs.

According to the invention, the edge of the simulation domain 13 could, in addition, also be set further to the left, with the result that for example only the cavity 3, or the cavity 3 with the sprue region 4 and/or the machine nozzle 5, is also included.

In the present embodiment example, at least one simulation 15 is performed on the simulation domain 13, wherein the injection of a molding material 10 into the at least one cavity 3 of the mold 2 is simulated by predefining at least one volume flow profile 19 through an inlet face 14 at the edge of the simulation domain 13 as boundary condition. The simulation 13 can for example be performed as a CFD simulation. The compression of the molding material 10 in the simulation domain 13 is also taken into account.

By means of a simulation 15 in a restricted simulation domain 13, an optimization of the boundary conditions can be carried out relatively easily, wherein several simulations 15 are carried out, preferably iteratively, with different boundary conditions and particularly preferably wherein the boundary conditions are adapted to at least one simulation 15 performed beforehand depending on the simulation result.

The aim of the optimization can be defined as an optimization of the melt front speed, for example. FIG. 3a shows the melt fronts 17 at fixed time intervals with a constant volume flow profile into the simulation domain 13. If the melt fronts 17 are close to one another, the flow rate is low. If the melt fronts 17 are far apart from one another, the flow rates are high. Melt front speeds that are too high or too low can, among other things, lead to surface defects on the component. The aim is therefore a melt front speed that is as constant as possible. The melt fronts 17 should therefore have distances from one another that are as constant as possible.

By means of the simulation 15 in the restricted simulation domain 13, this can be achieved relatively easily by varying the boundary conditions. FIG. 3b shows the result of an optimization: the melt fronts 17 have a relatively constant distance from one another.

The simulation domain 13 of the named optimized simulation comprises the cavity 3, the sprue region 4, the machine nozzle 5 and the barrel flange 6. In this simulation domain 13, the compression of the molding material 10 is also taken into account.

The volume flow profile 19, which results in the mentioned optimal result, is represented in FIG. 4a. The volume flow profile 19 is given in relative units, to the degree of filling of the cavity 3 in percent.

A volume flow profile calculated in each case in the simulation 15 and, analogously, a pressure (in each case through or at the inlet face) are represented in FIGS. 4b and, respectively, 4c, wherein these variables are in each case plotted over time (absolute volume flow rate and absolute pressure).

It should be mentioned that the volume flow profile 19 as boundary condition can also be easily converted into absolute values, for example by predefining an injection time to be achieved.

A conversion of a volume flow profile 19 via an absolute volume into a volume flow profile over time is also possible, for which reference is to be made below to FIGS. 7a, 7b, 8 and the associated statements.

It should furthermore be mentioned that the volume flow profile 19 as boundary condition, which was converted into absolute values, can be easily distinguished from the volume flow rate calculated in the simulation (FIG. 4b). This can be due, on the one hand, to the conversion itself, for example because the predefined injection time was not achieved accurately in the simulation, or, on the other hand, to the numerical nature of the simulation. Both the simulation result (volume flow profile from FIG. 4b) and the optimized boundary condition (volume flow profile from FIG. 4a) can be used for the conversion described below. This can apply analogously to the pressure at the inlet face.

As a result, the at least one volume flow profile (in this embodiment example the volume flow profile calculated in the simulation) is to be converted into a nominal profile for the movement of the injection actuator 8 (see conversion 16 in FIG. 1). With the nominal profile, a molding machine 1 can then be parameterized or further simulations can be carried out within a larger region. For example, the result can be conveyed to a drive 12 of the injection actuator 8, as represented in FIG. 1.

In this application, a simulation within a larger region is called overall simulation 20, wherein the overall simulation 20 simulates the injection of the molding material 10 into the cavity 3 of the mold 2 and the molding material 10 in a barrel 7 of the molding machine 1 taking into account the movement of the injection actuator 8 according to the nominal profile from the conversion 16.

This conversion 16 is effected by means of a mathematical model for calculating the mass of the molding material 10 between the injection actuator 8 and the inlet face 14, wherein a compressibility of the molding material 10 is taken into account in the conversion 16.

At least one volume flow profile 19 and at least one pressure profile at the inlet face 14 at the edge of the simulation domain 13 are known from the simulation 15 (either as a volume flow profile calculated in the simulation or as boundary condition of the simulation). In other words, at particular points in time t the pressure pᵢ and the volume flow rate \dot{V}ᵢ at the inlet face 14 are known.

As the first step of the conversion 16, a physical model is used for the relationship between pressure, temperature and density. A density profile at the inlet face 14 can thus be calculated from the pressure profile at the inlet face 14.

A Tait approach can for example be used as a physical model for the relationship between pressure, temperature and density. If the density is written as a specific volume

p=v⁻¹

the Tait approach can be written mathematically as follows:

$$v ( T , p ) = ( {b}_{1 m} + {b}_{2 m} ( T - {b}_{5} ) ) [ 1 - C ln ( 1 + \frac{p}{{b}_{3 m} {e}^{[ - b {4}_{m} ( T - {b}_{5} ) ]}} ) ]$$

wherein T is the absolute temperature, p is the pressure and C is a constant. The coefficients b1m to b4m and b5 are model parameters fitted to measured data.

Of course, any other physical relationship between pressure, temperature and density can also be used, for example a Renner approach and/or an IKV approach.

Through the use of the physical model for the relationship between pressure, temperature and density the compressibility is taken into account.

In a further step, a mathematical model is used for calculating the mass of the molding material 10 between the injection actuator 8 and the inlet face 14. In particular, the mass profile of the molding material 10 between the injection actuator 8 and the inlet face 14 is determined iteratively via a mass balance. Accordingly, the mass of the molding material 10 between the injection actuator 8 and the inlet face 14 at the point in time t can be calculated from the following formula:

mᵢ=mᵢ₋₁−\dot{V}ᵢρᵢΔt

Here, mᵢ denotes the iteratively calculated masses, \dot{V}ᵢ denotes the volume flow rate, ρᵢ denotes the density and Δt denotes the length of the time steps indexed with the index i.

A mass of the molding material 10 flowing off into the simulation domain 13 is thus calculated from the at least one volume flow profile 19 through the inlet face 14 and the at least one density profile at the inlet face 14 and iteratively subtracted. The density profile can, as described above, be calculated by means of a physical model for the relationship between pressure, temperature and density from a pressure profile, which is again known from the boundary conditions of the simulation 15. Here, Δt is the step width between two time steps.

The initial mass m₀ can be calculated by means of the metering volume V⁰ necessary for the simulation 15 and the density ρ₀ of the molding material at mass temperature and ambient pressure using

m₀=V₀ρ₀

If, for example, a hot runner is not also modeled, it may be necessary to choose another initial volume V₀.

In a further step of the conversion 16, the molding material 10 between the injection actuator 8 and the inlet face 14 is assigned a pressure profile and/or a spatial pressure distribution profile using the at least one pressure profile at the inlet face 14. A pressure beyond the simulation domain 13 is therefore assumed.

A density profile and/or a spatial density distribution profile of the molding material 10 between the injection actuator 8 and the inlet face 14 can be calculated from the pressure profile and/or the spatial pressure distribution profile of the molding material 10 between the injection actuator 8 and the inlet face 14, preferably wherein a physical model is used for the relationship between pressure, temperature and density, particularly preferably a Tait approach, a Renner approach and/or an IKV approach.

In the embodiment example presented, the pressure profile, and thus the density profile, of the molding material 10 between the injection actuator 8 and the inlet face 14 is assumed to be spatially uniform and/or to correspond to the pressure profile at the inlet face 14. A constant temperature is also assumed.

Alternatively, a pressure and/or temperature gradient which would result in a density distribution can also be assumed.

With the assigned density, a volume Vᵢ^{z}=mᵢ/ρᵢ of the molding material between injection actuator 8 and inlet face 14 can be calculated from a calculated mass mᵢ. In the present embodiment example, this corresponds to the molding material in the barrel 7.

A change in volume (Vᵢ₋₁^{z}−Vᵢ^{z})/Δt of the molding material 10 between the injection actuator 8 and the inlet face 14, thus here in particular in the barrel 7, in a time step Δt can accordingly also be calculated. This profile of the change in volume can be interpreted as nominal volume flow profile 21.

FIG. 4d shows the resulting nominal volume flow profile 21 in the barrel 7 as a function of time.

A nominal profile for the movement of the injection actuator 8 can then be calculated from a nominal volume flow profile 21 calculated in such a way. For this, only geometric data such as the barrel diameter need to be known. Such a calculation can also be effected automatically on the molding machine 1. The nominal volume flow profile 21 can therefore also be input directly on the molding machine 1.

Before the transfer to a molding machine 1, the number of points of the nominal profile for the movement of the injection actuator 8 can be reduced by means of a reduction algorithm to an amount that is suitable for the machine control system of the molding machine 1.

FIG. 5 accordingly shows a nominal volume flow profile 21 of the molding material 10 between the injection actuator 8 and the inlet face 14 as a function of time with a reduced number of points, which nominal volume flow profile can be converted on the molding machine 1 into a nominal profile for the movement of the injection actuator 8 with a reduced number of points.

Before or after the reduction of the number of points of the nominal profile, a further optimization can also be carried out by again using the calculated nominal volume flow profile 21 as boundary condition for the simulation 15, resulting in a feedback loop. This is indicated in FIG. 1 by an arrow from the conversion 16 to the simulation 15.

Thereafter, an overall simulation 20 can be carried out, wherein the overall simulation 20 simulates the injection of the molding material 10 into the cavity 3 of the mold 2 and the molding material 10 in a barrel 7 of the molding machine 1 taking into account the movement of the injection actuator 8 according to the nominal profile from the conversion 16.

FIG. 6 shows a filling image as in FIGS. 3a and 3b, which was created using an overall simulation 20 and the nominal profile for the movement of the injection actuator 8 obtained from the conversion 16. The melt fronts are still at a constant spacing from one another; only a slight difference from FIG. 3b can be seen. The optimization, which is easy to carry out and was carried out for the simulation 15 in the simulation domain 13, can therefore still be seen in the results of the overall simulation 20.

An optimization at the level of the overall simulation 20 can again be carried out. The calculated nominal profile for the movement of the injection actuator 8 provides a suitable initial value for this purpose.

FIG. 7a depicts a further (predefined or calculated) volume flow profile 19, which is plotted over an absolute filled volume. This can be converted into a volume flow profile 19 which is plotted over time, which is represented in FIG. 7b.

To illustrate how this conversion can proceed, for example, a graph is represented in FIG. 8, wherein a volume flow rate is plotted over the absolute filled volume and wherein a value interval (small triangle) is drawn in, in which the following observations take place.

In principle, in this region there is a linear dependence of the volume flow rate on the volume, with the result that

\dot{V}=kV.

In this case k is a predefined proportionality constant. It follows from this:

$$\frac{dV}{dt} = k . V \to \frac{dV}{k . V} = dt \\ \to \frac{1}{k} {\int }_{{V}_{0}}^{{V}_{1}} \frac{dV}{V} = \text{?} dt$$

$$\text{?} \text{indicates text missing or illegible when filed}$$

Integration gives

$$\frac{1}{k} ( ln ( {V}_{1} ) - ln ( {V}_{0} ) ) = {t}_{1} - {t}_{0} = Δ t$$

For the i-th time interval, the following results from this (expressed as a function of the degree of filling instead of absolute volume, referred to as a delta t equation):

$${Δ t}_{i} = \frac{( \% {V}_{i} - \text{?} ) ⋆ 0.01 ⋆ volume to be filled}{\text{?}} ⋆ ln \frac{{V}_{i}}{\text{?}}$$

$$\text{?} \text{indicates text missing or illegible when filed}$$

wherein % Vᵢ is the degree of filling given in percent and “volume to be filled” is the total volume of the simulation domain 13. Alternatively, the “volume to be filled” could be the volume initially not filled (for example a cavity 3 together with a sprue 4). In a first step, the relatively expressed volume flow rate with units of a volume flow rate is assumed for the volume flow rates V i.e.

\dot{V}ᵢ[cm³/s]=% Vᵢ*1 cm³/s. The inaccuracy thus introduced is corrected by the scaling that is described later.

These observations further make it possible to take the compressibility of the molding material 10 into account in the conversion 16.

The starting point on the one hand is a calculated or predefined volume flow profile 19, which is to be converted into a nominal profile according to the invention taking the compressibility of the molding material 10 into account, as represented for example in FIG. 9.

On the other hand, as a rule information about the progression of the degree of filling of the simulation domain 13 is available from the simulation 15. For example, a screenshot showing a table which contains, among other things, time indices and the degree of filling in percent (see superposed frame) is represented in FIG. 10.

In the embodiment example presented in this connection, the aim is first of all to calculate a proto-nominal volume flow profile 22 (see also FIG. 12), wherein the compressibility of the molding material 10 is not taken into account. This can in principle be effected easily as in the state of the art on the basis of volumetric considerations in the barrel.

In a next step, the proto-nominal volume flow profile 22 is then scaled such that the degree of filling at various times in the process corresponds to those degrees of filling which are represented in FIG. 10. As a result, the compressibility of the molding material 10 is at least approximately taken into account in a clever manner, because the compressibility is taken into account in the simulation 15 in the simulation domain 13. Without having to make use of models in the region between the injection actuator 8 and the inlet face 14, the compressibility of the molding material can thus be taken into account in the conversion.

To actually carry out this embodiment example, it can be provided that the volume flow profile 19 to be converted is sampled, in other words a quantity of value pairs are created, which lie on the graph of the volume flow profile 19 to be converted. This is represented in FIG. 11.

Alternatively, one or more scale factors could be calculated. For example, the results from the simulation 15 (see FIG. 10) could be inserted into the delta t equation and the corresponding time intervals added up.

By predefining a desired injection time (referred to as “nominal injection time”), a scale factor for the time axis in FIG. 12 could be calculated as follows:

$$scale factor = \frac{ΣΔ {t}_{i}}{nominal injection time}$$

Another possibility for calculating the scale factor would be, for example, to predefine a desired volume flow rate (referred to as “nominal flow rate”) and the following equation:

$$scale factor = \frac{nominal flow rate ⋆ ΣΔ {t}_{i}}{volume to be filled}$$

As above, the parameter “volume to be filled” would be the volume of the simulation domain 13.

For the sake of completeness it may be mentioned that the following relationship exists:

$$nominal injection time = \frac{volume to be filled}{nominal flow rate}$$

The actual volume flow rate then results, for each of the points, as the scaled volume flow rate assumed above as a first approximation:

\dot{V}ᵢ=\dot{V}ᵢ*scale factor

The scaling of the proto-nominal volume flow profile 22 over time can be seen in FIG. 12.

The scaling over time in FIG. 12 results through the assignment of the scaled volume flow rates to the times which are represented in FIG. 10 in relation to the respective filling levels.

In other words, via the table from FIG. 10, the degrees of filling from these value pairs can be assigned to absolute times—if necessary by interpolation—and as a result the volume flow rates can be plotted against these times as a converted nominal volume flow profile 21, which results in the scaled nominal volume flow profile 21 from FIG. 12.

Due to the compressibility of the molding material 10 a longer filling time results, which is taken into account by the described scaling.

It should be noted that, after the scaling, a reduction of the value pairs can be carried out, for example using the Ramer-Douglas-Peucker algorithm.

The nominal profile for the movement of the injection actuator 8 can, as mentioned, be determined from the nominal volume flow profile 21 calculated in such a way. It should be mentioned that the described scaling could in principle be carried out on the nominal profile instead of on the nominal volume flow profile 21.

Tests by the applicant have shown that nominal profiles for the injection actuator 8 can be calculated using the conversion according to this embodiment example, with the result that there is a very good correspondence between the actual process and the simulation 15.

### LIST OF REFERENCE NUMBERS

1 molding machine
2 mold
3 cavity
4 sprue region
5 machine nozzle
6 barrel flange
7 barrel
8 injection actuator
9 plasticizing screw
10 molding material
11 hopper
12 drive
13 simulation domain
14 inlet face
15 simulation
16 conversion
17 melt front
18 injection unit
19 volume flow profile
20 overall simulation
21 nominal volume flow profile
22 proto-nominal volume flow profile

1. Computer-implemented method for calculating a nominal profile for the movement of an injection actuator of a molding machine, wherein
a simulation domain is defined, wherein the simulation domain comprises at least one cavity of a mold installed on the molding machine,
at least one simulation is performed in the simulation domain, wherein the injection of a molding material into the at least one cavity of the mold is simulated by predefining at least one volume flow profile through an inlet face at the edge of the simulation domain and/or by predefining at least one pressure profile at the inlet face as boundary condition,
a volume flow profile calculated using the simulation and/or the at least one volume flow profile is converted into a nominal profile for the movement of an injection actuator, in particular a plasticizing screw,
a compressibility of the molding material is taken into account in the conversion.

2. The computer-implemented method for simulating the injection of the molding material into a cavity, in particular according to claim 1, wherein
a simulation domain is defined, wherein the simulation domain comprises at least one cavity of a mold installed on the molding machine,
at least one simulation is performed in the simulation domain, wherein the injection of a molding material into the at least one cavity of the mold is simulated by predefining at least one volume flow profile through an inlet face at the edge of the simulation domain and/or by predefining at least one pressure profile at the inlet face as boundary condition,
a volume flow profile calculated using the simulation and/or the volume flow profile is converted into a nominal profile for the movement of an injection actuator, in particular a plasticizing screw,
wherein
an overall simulation is then carried out, wherein the overall simulation simulates the injection of the molding material into the cavity m of the mold and the molding material in a barrel of the molding machine taking into account the movement of the injection actuator according to the nominal profile from the conversion.

3. The method according to claim 1, wherein the compressibility of the molding material between the injection actuator and the inlet face is taken into account in the conversion.

4. The method according to claim 1, wherein the compressibility of the molding material is taken into account in the conversion by scaling the nominal profile such that a volume resulting from the nominal profile and entering the inlet face for each time step corresponds to a volume, calculated in the simulation, of the molding material in the simulation domain and/or in the cavity at the respective time step, preferably wherein the nominal profile is calculated before the scaling without taking the compressibility into account.

5. The method according to claim 1, wherein an optimization of the boundary conditions is carried out, preferably wherein several simulations are carried out iteratively with different boundary conditions, particularly preferably wherein the boundary conditions are adapted to at least one simulation performed beforehand depending on the simulation result.

6. The method according to claim 1, wherein the simulation domain comprises
at least one sprue region, and/or
at least one hot runner system, and/or
at least one machine nozzle, and/or
at least one barrel flange.

7. The method according to claim 1, wherein the simulation and/or the overall simulation is a CFD simulation.

8. The method according to claim 7, wherein a density profile at the inlet face is calculated from the volume flow profile and/or the pressure profile at the inlet face, preferably wherein a physical model is used for the relationship between pressure, temperature and density, particularly preferably a Tait approach, a Renner approach and/or an IKV approach.

9. The method according to claim 8, wherein the molding material between the injection actuator and the inlet face is assigned a barrel pressure profile and/or a spatial pressure distribution profile using the at least one pressure profile at the inlet face, preferably wherein the barrel pressure profile or the pressure distribution profile of the molding material between the injection actuator and the inlet face
is assumed to be spatially uniform and/or to correspond to the pressure profile at the inlet face, and/or
is assumed to be ascending or descending with a gradient.

10. The method according to claim 9, wherein a density profile and/or a spatial density distribution profile of the molding material between the injection actuator and the inlet face is calculated from the barrel pressure profile and/or the spatial pressure distribution profile of the molding material between the injection actuator and the inlet face, preferably wherein a physical model is used for the relationship between pressure, temperature and density, particularly preferably a Tait approach, a Renner approach and/or an IKV approach.

11. The method according to claim 1, wherein a mass profile of the molding material between the injection actuator and the inlet face is determined, in particular iteratively, via a mass balance, preferably wherein
a mass of the molding material flowing off into the simulation domain is calculated from the at least one volume flow profile through the inlet face and the at least one barrel pressure profile at the inlet face and is particularly preferably iteratively subtracted, and/or
a mass of the molding material flowing off via a non-return valve of the injection actuator is taken into account.

12. The method according to claim 11, wherein a nominal volume flow profiler of the molding material between the injection actuator and the inlet face is calculated from the mass profile, preferably wherein the density profile and/or the density distribution profile of the molding material between the injection actuator and the inlet face is used, and wherein a nominal profile for the movement of the injection actuator is calculated from the nominal volume flow profile.

13. The method according to claim 1, wherein the number of points of the nominal volume flow profile for the movement of the injection actuator is reduced by means of a reduction algorithm to an amount that is suitable for the machine control system of the molding machine.

14. The method for operating a molding machine, wherein
a nominal profile for the movement of the injection actuator of the molding machine is calculated according to claim 1,
the nominal profile for the movement of the injection actuator is transferred to the molding machine,
a molding process is performed on the molding machine using the nominal profile for the movement of the injection actuator.

15. The method according to claim 1 for the transfer and adaptation of a nominal profile for the movement of a further injection actuator from a further molding machine to the at least one molding machine, wherein
at least one molding process is performed on at least one further molding machine with a nominal profile for the movement of a further injection actuator,
at least one further overall simulation of the at least one molding process is carried out on the further molding machine,
a further simulation domain is defined, wherein the further simulation domain comprises the at least one cavity of the mold installed on the further molding machine,
the nominal profile for the movement of a further injection actuator of the further molding machine is converted into a volume flow profile through an inlet face and/or at least one pressure profile at the inlet face at the edge of the further simulation domain, and
the method according to claim 1 is carried out with the volume flow profile and/or the pressure profile.

16. A molding machine, which is designed to perform the method according to claim 14.

17. A computer program product, comprising commands which cause a molding perform to perform the method according to claim 14.

18. A computer program product, comprising commands which prompt a computer executing them to perform the method according to claim 1 with the predefined simulation domain.
